(19) United States
(12) Patent Application Publication
(10) Pub. No.: US 2020/0271537 A1
(43) Pub. Date: Aug. 27, 2020

(54) SECOND HARMONIC RUNOUT SIMULATION HUB

(71) Applicant: CITIC Dicastal CO., LTD., Qinhuangdao (CN)

(72) Inventors: Jinqi LYU, Qinhuangdao (CN); Zhigao YIN, Qinhuangdao (CN); Hanbao SUN, Qinhuangdao (CN)

(73) Assignee: CITIC Dicastal CO., LTD., Qinhuangdao (CN)

(21) Appl. No.: 16/552,560

(22) Filed: Aug. 27, 2019

(30) Foreign Application Priority Data
Feb. 27, 2019 (CN) 201910145393.8

(51) Int. Cl. G01M 1/04; G01M 1/16

(52) U.S. Cl. CPC G01M 1/04; G01M 1/16

(57) ABSTRACT

A second harmonic runout simulation hub includes an outer ring, an end plate and a clamping portion fixed to each other. The end plate is at one end of the outer ring, and the clamping portion is detachably fixed to the end plate. The clamping portion includes a first positioning hole for positioning and clamping. The first positioning hole is a cylindrical hole, and the cylindricity of the first positioning hole is smaller than a preset value. The outer circumference of the outer ring includes a measuring cylindrical surface having a preset axial length and a bus parallel to the axis of the first positioning hole, and the circular runout test values of the measuring cylindrical surface are preset second harmonic runout values.

### CROSS-REFERENCE TO RELATED APPLICATION

The present application claims benefit of Chinese Patent Application No. 201910145393.8, filed on Feb. 27, 2019, the contents of which are hereby incorporated by reference in their entirety.

### BACKGROUND

The motor vehicle hub runout tester is a test device special for detecting the runout of a motor vehicle hub. Since the motor vehicle hub (hereinafter referred to as the hub) is deformed during machining and heat treatment to cause a deviation in the shape of the hub, the deviation needs to be tested by a runout tester. The most common shape deviation indicates that the outer circumference of the hub is elliptical. After the outer circumference of the hub is elliptical, the increase in fluctuation of the circular runout of the outer circumference of the hub can be tested by the runout tester. Specifically, when the hub having an elliptical outer circumference is tested on the runout tester, two maximum runout values (peak values) and two minimum runout values (trough values) appear in one rotating circumference. Such circular runout having two peak values and two trough values in one rotating circumference is referred to as second harmonic runout in engineering. The hub with second harmonic runout may cause bumps in the driving process of the motor vehicle, which is not safe and comfortable for a user. Therefore, such hubs should be sorted out to avoid mounting on motor vehicles. Thus, runout tests are required for ordinary hub products, and hub manufacturers are also equipped with motor vehicle hub runout testers.

The motor vehicle hub runout testers include contact and non-contact ones according to the test methods. The contact test principle indicates that a measuring component is used to be in contact with an inner or outer bead seat of a tested hub, and when the hub rotates, the runout of the inner or outer bead seat is transmitted to a displacement sensor through the measuring component, thereby realizing a hub runout test. The non-contact runout tester uses laser as a test source, the laser is directly projected onto an inner or outer bead seat of a tested hub, and the reflected light is tested to calculate the amount of runout when the hub rotates.

However, since all the hubs need to be tested, the test amount is relatively large. Either type of motor vehicle hub tester is gradually worn during use to lose the test accuracy. Accordingly, a standard hub (i.e., a defective product) having determined second harmonic runout values is required for verifying the accuracy and stability of second harmonic runout of the runout tester to ensure that the test data of the runout tester is accurate and reliable. At the same time, when test comparison is required for different hub runout testers, a standard hub having determined second harmonic runout values is also required to complete the comparison of second harmonic runout test results between different devices.

However, the verification directly using the real hub has the following problems:

1) Ordinary hubs are produced in mass with relatively stable quality, and it is difficult to find a hub having determined second harmonic runout values that are relatively large;

2) After the standard hub made of an ordinary hub is tested multiple times on the runout tester, the second harmonic runout value is easily changed due to wear, resulting in inaccurate verification;

3) The standard hub made of the ordinary hub is easily confused with the ordinary hub and flows into next procedure after verification, resulting in the loss of the standard hub and the introduction of defective products into the next procedure.

### SUMMARY

The present disclosure relates to a motor vehicle wheel manufacturing technology, in particular to a second harmonic runout simulation hub.

In view of the above, embodiments of the present disclosure is desired to provide a second harmonic runout simulation hub, which can accurately verify a runout tester, has a long service life, and is not confused with an ordinary motor vehicle hub.

In order to achieve the above objective, the technical solution of the present disclosure is implemented as follows:

Embodiments of the present disclosure provide a second harmonic runout simulation hub, including an outer ring, an end plate and a clamping portion fixed to each other, the end plate is at one end of the outer ring, and the clamping portion is detachably fixed to the end plate; the clamping portion includes a first positioning hole for positioning and clamping, the first positioning hole is a cylindrical hole, and the cylindricity of the first positioning hole is smaller than a preset value; the outer circumference of the outer ring includes a measuring cylindrical surface having a preset axial length and a bus parallel to the axis of the first positioning hole, and the circular runout test values of the measuring cylindrical surface are preset second harmonic runout values.

In the above solution, the clamping portion further includes a boss assembled with the end plate, the end plate includes a second positioning hole matching the boss, and after the boss is mounted into the second positioning hole, the parallelism between the bus of the measuring cylindrical surface and the axis of the first positioning hole is smaller than a preset value.

In the above solution, the outer side of the measuring cylindrical surface is provided with a measuring vertical surface, and the angle between the measuring vertical surface and the measuring cylindrical surface is 80 to 90 degrees.

In the above solution, the clamping portion further includes an end face positioning surface matching the runout tester, the end face positioning surface is at one end of the clamping portion, and the perpendicularity between the end face positioning surface and the axis of the first positioning hole is smaller than a preset value.

In the above solution, the clamping portion further includes at least two threaded holes, the axes of the threaded holes are parallel to the axis of the first positioning hole, and the end plate further includes screw through holes, with the positions of the screw through holes matching the threaded holes; the clamping portion and the end plate are fixed as follows: after the boss is assembled with the second positioning hole, screws pass through the screw through holes and are screwed into the threaded holes for fixing.

In the above solution, the end plate is provided with at least two lightening holes uniformly distributed along the circumference, and the radial distances between the lightening holes and the measuring cylindrical surface are greater than a preset value.

Provided are a second harmonic runout simulation hub and a verification method according to the embodiments of the present disclosure, where the simulation hub includes an outer ring, an end plate and a clamping portion fixed to each other, the end plate is at one end of the outer ring, and the clamping portion is detachably fixed to the end plate; the clamping portion includes a first positioning hole for positioning and clamping, the first positioning hole is a cylindrical hole, and the cylindricity of the first positioning hole is smaller than a preset value; the outer circumference of the outer ring includes a measuring cylindrical surface having a preset axial length and a bus parallel to the axis of the first positioning hole, and the circular runout test values of the measuring cylindrical surface are all preset second harmonic runout values. Hence, the second harmonic runout simulation hub and the verification method according to the embodiments of the present disclosure can accurately verify a runout tester, and the simulation hub has a long service life and is not confused with an ordinary motor vehicle hub.

Other advantageous effects of the embodiments of the present disclosure will be further described in conjunction with specific technical solutions in the specific embodiments.

### BRIEF DESCRIPTION OF DRAWINGS

FIG. 1 is a schematic diagram of a second harmonic runout simulation hub according to an embodiment of the present disclosure;

FIG. 2 is a right-side view of a second harmonic runout simulation hub according to an embodiment of the present disclosure;

FIG. 3 is a schematic diagram of a clamping portion of the second harmonic runout simulation hub according to an embodiment of the present disclosure;

FIG. 4 is a schematic flowchart of a using method of the second harmonic runout simulation hub according to an embodiment of the present disclosure.

### DETAILED DESCRIPTION

It should be noted that, in the description of the embodiments of the present disclosure, unless otherwise stated and limited, the term “connected” shall be understood broadly, for example, it may be an electrical connection, an internal communication between two components, a direct connection, or an indirect connection by an intermediate medium, and the specific meaning of the term may be understood by those of ordinary skill in the art according to the specific circumstances.

It should be noted that, the terms “first\second\third” involved in the embodiments of the present disclosure are only intended to distinguish similar objects, but do not represent specific orders of the objects, and understandably, the “first\second\third” may be interchanged in a specific order or consecutive.

Embodiments of the present disclosure provide a second harmonic runout simulation hub, including an outer ring, an end plate and a clamping portion fixed to each other, the end plate is at one end of the outer ring, and the clamping portion is detachably fixed to the end plate; the clamping portion includes a first positioning hole for positioning and clamping, the first positioning hole is a cylindrical hole, and the cylindricity of the first positioning hole is smaller than a preset value; the outer circumference of the outer ring includes a measuring cylindrical surface having a preset axial length and a bus parallel to the axis of the first positioning hole, and the circular runout test values of the measuring cylindrical surface are all preset second harmonic runout values.

The measuring cylindrical surface is a surface for measuring circular runout; the simulation hub is fixed to a motor vehicle hub runout tester through the first positioning hole, the motor vehicle hub runout tester is provided with a clamp including an expansion column, and the expansion column is inserted into the first positioning hole and then expands to clamp the simulation hub. The outer ring and the end plate may be integrally formed, and therefore are higher in positional accuracy and low in manufacturing cost.

The cylindricity of the first positioning hole is smaller than a preset value, so that the positioning is more accurate; the axial length of the measuring cylindrical surface is preset to facilitate the contact with a measuring head for measuring the circular runout; the circular runout test values of the measuring cylindrical surface are all preset second harmonic runout values, that is, the simulation hub is a defective product, which is caused by an elliptical shape, so that the motor vehicle hub runout tester can be verified.

The second harmonic runout simulation hub according to the embodiments of the disclosure can accurately verify the runout tester, has a long service life, and is not confused with an ordinary motor vehicle hub. Moreover, the second harmonic runout simulation hub according to the embodiments of the present disclosure is further improved in shape, from approximately two measuring cylindrical surfaces of an ordinary hub to one measuring cylindrical surface, so that higher manufacturing precision is obtained more easily, the weight of the simulation hub is reduced, the verification is more accurate, and the service life of the simulation hub is prolonged. In addition, the structure of only one measuring cylindrical surface expands the movement space of the measuring head of the runout tester, so that the operation is more convenient.

In an embodiment, the clamping portion further includes a boss assembled with the end plate, the end plate includes a second positioning hole matching the boss, and after the boss is mounted into the second positioning hole, the parallelism between the bus of the measuring cylindrical surface and the axis of the first positioning hole is smaller than a preset value. In this way, the clamping portion and the end plate are assembled more easily, and are positioned more accurately. After the boss is mounted into the second positioning hole, the parallelism between the bus of the measuring cylindrical surface and the axis of the first positioning hole is smaller than a preset value, which puts forward requirements for the sizes, shapes and positions of the boss and the second positioning hole.

In an embodiment, the outer side of the measuring cylindrical surface is provided with a measuring vertical surface, and the angle between the measuring vertical surface and the measuring cylindrical surface is 80 to 90 degrees. Thus, the axial circular runout can also be measured besides the radial circular runout, where the radial circular runout is outer circular runout, and the axial circular runout is end face circular runout. The angle between the measuring vertical surface and the measuring cylindrical surface is 80 to 90 degrees, which facilitates simultaneous placement of a radial measuring head for measuring the radial circular runout and an axial measuring head for measuring the axial circular runout.

In an embodiment, the clamping portion further includes an end face positioning surface matching the runout tester, the end face positioning surface is at one end of the clamping portion, and the perpendicularity between the end face positioning surface and the axis of the first positioning hole is smaller than a preset value, that is, a good perpendicularity can ensure that the positioning of the simulation hub is more accurate. On the basis of the positioning of the first positioning hole, the end face positioning surface is added, so that the positioning is more reliable. It can be understood that if the cylindricity of the first positioning hole and the parallelism with the measuring cylindrical surface meet the preset requirements, accurate positioning can also be achieved by only the first positioning hole.

In an embodiment, the clamping portion further includes at least two threaded holes, the axes of the threaded holes are parallel to the axis of the first positioning hole, and the end plate further includes screw through holes, with the positions of the screw through holes matching the threaded holes; the clamping portion and the end plate are fixed as follows: after the boss is assembled with the second positioning hole, screws pass through the screw through holes and are screwed into the threaded holes for fixing. This is simple to fix and easy to assemble and disassemble.

In an embodiment, the end plate is provided with at least two lightening holes uniformly distributed along the circumference, and the radial distances between the lightening holes and the measuring cylindrical surface are greater than a preset value. In this way, it can be prevented that the simulation hub is too heavy so as to increase the load of the motor vehicle hub runout tester, and the too heavy simulation hub easily causes the clamp to loosen and deviate from position. The radial distances between the lightening holes and the measuring cylindrical surface are greater than a preset value, which is to ensure the strength of the simulation hub.

The present disclosure will be described in detail below with reference to the accompanying drawings and specific embodiments. It should be understood that the specific embodiments described herein are merely used for interpreting the present disclosure, rather than limiting the present disclosure.

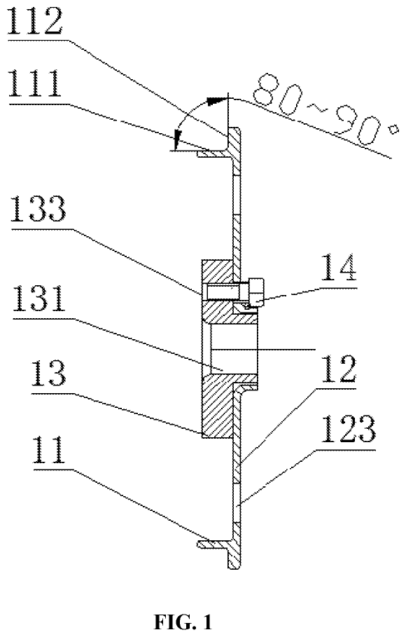

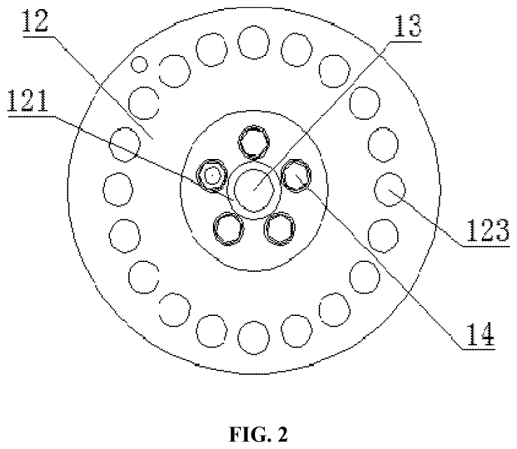

FIG. 1 is a schematic diagram of a second harmonic runout simulation hub according to an embodiment of the present disclosure, and FIG. 2 is a right-side view of the second harmonic runout simulation hub illustrated in FIG. 1. As shown in FIG. 1 and FIG. 2, the second harmonic runout simulation hub includes an outer ring 11, an end plate 12 and a clamping portion 13 fixed to each other, the end plate 12 is at one end of the outer ring 11, and the clamping portion 13 is detachably fixed to the end plate 12; the clamping portion 13 includes a first positioning hole 131 for positioning and clamping, the first positioning hole 131 is a cylindrical hole, and the first positioning hole 131 is used for matching a clamp of a motor vehicle hub runout tester; the cylindricity of the first positioning hole 131 is smaller than a preset value to achieve accurate positioning; the outer circumference of the outer ring 11 includes a measuring cylindrical surface 111 having a preset axial length and a bus parallel to the axis of the first positioning hole 131, and the circular runout test values of the measuring cylindrical surface 111 are all preset second harmonic runout values, that is, the measuring cylindrical surface 111 is a surface for measuring circular runout, and the simulation hub is a defective product, which is caused by an elliptical shape, so that the motor vehicle hub runout tester can be verified.

In the embodiment, the outer ring 11 and the end plate 12 are integrally formed, and therefore are higher in positional accuracy and low in manufacturing cost.

In the embodiment, the clamping portion 13 further includes a boss 132 assembled with the end plate 12, the end plate 12 includes a second positioning hole 121 matching the boss 132, and after the boss 132 is mounted into the second positioning hole 121, the parallelism between the bus of the measuring cylindrical surface 111 and the axis of the first positioning hole 131 is smaller than a preset value, which puts forward requirements for the sizes, shapes and positions of the boss 132 and the second positioning hole 121. In this way, the clamping portion 13 and the end plate 12 are assembled more easily, and are positioned more accurately.

In the embodiment, the measuring cylindrical surface 111 is aligned at a radial outer end, and the radial dimension of the outer ring 11 at the outer circumference of the measuring cylindrical surface 111 is smaller than that of the measuring cylindrical surface 111. The measuring cylindrical surface 111 is aligned at the radial outer end, that is, the outer circular surface is equal-height in the horizontal plane, which is convenient for measurement, that is, the circular runout measuring head is easier to arrange. The radial dimension at the outer circumference of the measuring cylindrical surface 111 is smaller than that of the measuring cylindrical surface 111 for the purpose of yielding, that is, avoiding the touch of the measuring head to affect the measurement accuracy.

In the embodiment, the outer side of the measuring cylindrical surface 111 is provided with a measuring vertical surface 112, and the angle between the measuring vertical surface 112 and the measuring cylindrical surface 111 is 80 to 90 degrees, which facilitates simultaneous placement of a radial measuring head for measuring radial circular runout and an axial measuring head for measuring axial circular runout. Thus, the axial circular runout can also be measured besides the radial circular runout, where the radial circular runout is outer circular runout, and the axial circular runout is end face circular runout.

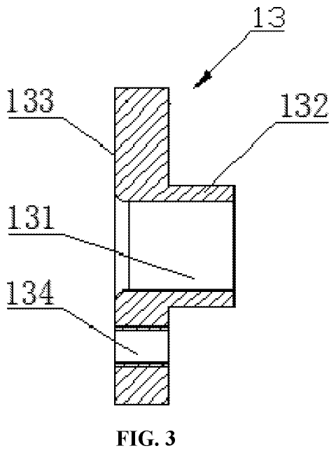

In the embodiment, as shown in FIG. 3, the clamping portion 13 further includes an end face positioning surface 133 matching the runout tester, the end face positioning surface 133 is at one end of the clamping portion 13, and the perpendicularity between the end face positioning surface 133 and the axis of the first positioning hole 131 is smaller than a preset value. On the basis of the positioning of the first positioning hole 131, the end face positioning surface 133 is added, so that the positioning is more reliable.

In the embodiment, the clamping portion 13 further includes five threaded holes 134, the axes of the threaded holes 134 are parallel to the axis of the first positioning hole 131, and the end plate 12 further includes screw through holes, with the positions of the screw through holes matching the threaded holes 134; the clamping portion 13 and the end plate 12 are fixed as follows: after the boss 132 is assembled with the second positioning hole 121, screws 14 pass through the screw through holes and are screwed into the threaded holes 134 for fixing. This is simple to fix and easy to assemble and disassemble.

In the embodiment, the end plate 12 is provided with a plurality of lightening holes 123 uniformly distributed along the circumference, and the radial distances between the lightening holes 123 and the measuring cylindrical surface 111 are greater than a preset value to ensure the strength of the simulation hub. In this way, it can be prevented that the simulation hub is too heavy so as to increase the load of the motor vehicle hub runout tester, and the too heavy simulation hub easily causes the clamp to loosen and deviate from position.

In order to further understand the second harmonic runout simulation hub according to the embodiments of the present disclosure, the following describes a using method of the second harmonic runout simulation hub:

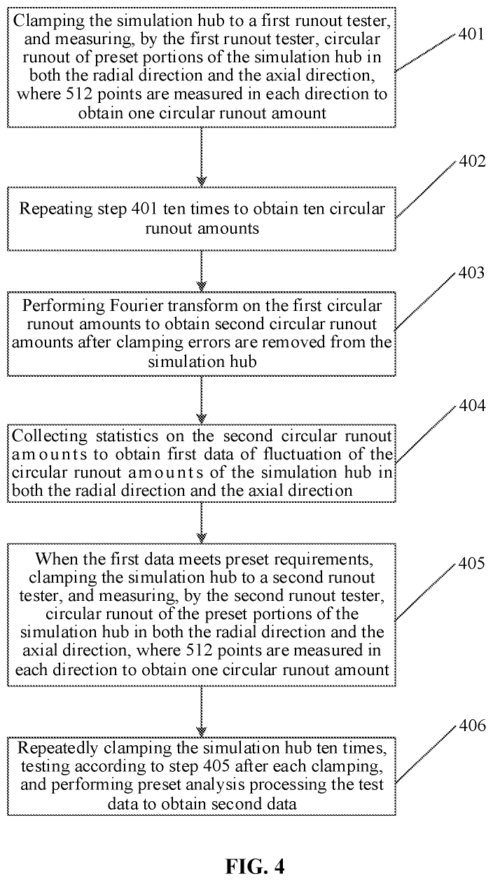

FIG. 4 is a schematic flowchart of a using method of the second harmonic runout simulation hub according to an embodiment of the present disclosure. As shown in FIG. 4, the method includes the following steps:

In step 401: the simulation hub is clamped to a first runout tester, the first runout tester measures circular runout of preset portions of the simulation hub in both the radial direction and the axial direction, where 512 points are measured in each direction to obtain one circular runout value; the preset portions are the measuring cylindrical surface 111 and the measuring vertical surface 112;

In step 402: step 401 is repeated ten times to obtain ten circular runout values, that is, first circular runout values; because of many measurement points and multiple tests, more accurate test data can be obtained;

In step 403: Fourier transform is performed on the first circular runout values to obtain second circular runout values after clamping errors are removed from the simulation hub; the clamping errors refer to errors caused by inaccurate positioning in clamping;

In step 404: statistics on the second circular runout values are collected to obtain first data of fluctuation of the circular runout values of the simulation hub in both the radial direction and the axial direction; specifically, the fluctuation is a sine curve, the specific analysis method is a runout harmonic analysis method, which is a common method for analyzing circular runout of a motor vehicle hub, details are not described herein, and reference may be made to the paper “Research on Calibration Method for Aluminum Alloy Hub Runout Tester” in the Journal “Engineering and Testing” in 2013 Issue 04;

In step 405: when the first data meets preset requirements, the simulation hub is clamped to a second runout tester, and the second runout tester measures circular runout of the preset portions of the simulation hub in both the radial direction and the axial direction, where 512 points are measured in each direction to obtain one circular runout value;

In step 406: the simulation hub is repeatedly clamped ten times and tested according to step 405 after each clamping, and preset analysis processing is performed on the test data to obtain second data; similar to step 404, the second data also reflects the fluctuation of circular runout of the simulation hub, and is a sine curve; here, the measurements after multiple times of clamping can verify the measurement accuracy of the second runout tester, and can also verify the clamping reliability of the second runout tester.

Through the above method, the simulation hub can accurately verify the runout tester, has a long service life, and is not confused with an ordinary motor vehicle hub.

The foregoing descriptions are merely preferred embodiments of the present disclosure, but are not intended to limit the protection scope of the present disclosure. Any modifications, equivalent substitutions, improvements and the like made within the spirit and principle of the present disclosure shall fall within the protection scope of the present disclosure.

1. A second harmonic runout simulation hub, comprising an outer ring, an end plate and a clamping portion fixed to each other, wherein the end plate is at one end of the outer ring, and the clamping portion is detachably fixed to the end plate; the clamping portion comprises a first positioning hole for positioning and clamping, the first positioning hole is a cylindrical hole, and the cylindricity of the first positioning hole is smaller than a preset value; the outer circumference of the outer ring comprises a measuring cylindrical surface having a preset axial length and a bus parallel to the axis of the first positioning hole, and the circular runout test values of the measuring cylindrical surface are preset second harmonic runout values.

2. The second harmonic runout simulation hub according to claim 1, wherein the clamping portion further comprises a boss assembled with the end plate, the end plate comprises a second positioning hole matching the boss, and after the boss is mounted into the second positioning hole, the parallelism between the bus of the measuring cylindrical surface and the axis of the first positioning hole is smaller than a preset value.

3. The second harmonic runout simulation hub according to claim 2, wherein the outer side of the measuring cylindrical surface is provided with a measuring vertical surface, and the angle between the measuring vertical surface and the measuring cylindrical surface is 80 to 90 degrees.

4. The second harmonic runout simulation hub according to claim 3, wherein the clamping portion further comprises an end face positioning surface matching the runout tester, the end face positioning surface is at one end of the clamping portion, and the perpendicularity between the end face positioning surface and the axis of the first positioning hole is smaller than a preset value.

5. The second harmonic runout simulation hub according to claim 1, wherein the clamping portion further comprises at least two threaded holes, the axes of the threaded holes are parallel to the axis of the first positioning hole, and the end plate further comprises screw through holes, with the positions of the screw through holes matching the threaded holes; the clamping portion and the end plate are fixed as follows: after the boss is assembled with the second positioning hole, screws pass through the screw through holes and are screwed into the threaded holes for fixing.

6. The second harmonic runout simulation hub according to claim 5, wherein the end plate is provided with at least two lightening holes uniformly distributed along the circumference, and the radial distances between the lightening holes and the measuring cylindrical surface are greater than a preset value.
